(19) United States
(12) Patent Application Publication
(10) Pub. No.: US 2010/0109995 A1
(43) Pub. Date: May 6, 2010

(54) GATE DRIVING DEVICE UTILIZED IN LCD DEVICE

(76) Inventor: Yu-Chieh Fang, Kaohsiung City (TW)

Correspondence Address: NORTH AMERICA INTELLECTUAL PROPERTY CORPORATION, P.O. BOX 506, MERRIFIELD, VA, 22116, US

(21) Appl. No.: 12/388,488

(22) Filed: Feb. 18, 2009

(30) Foreign Application Priority Data
Nov. 3, 2008 (TW) 097142341

(51) Int. Cl. G09G 3/36

(52) U.S. Cl. 345/100

(57) ABSTRACT

The present invention provides a gate driving device utilized in an LCD device, wherein the LCD device includes a plurality of gate lines, and the gate driving device includes: a plurality of output buffer units, at least a first switch unit, a plurality of second switch units, and a control module. The gate driving device disclosed in the present invention can utilize charge sharing to reduce the power consumption, so as to attain the purpose of efficiently saving the power.

### BACKGROUND OF THE INVENTION

1. Field of the Invention

The present invention relates to a gate driving device utilized in an LCD device, and more particularly, to a gate driving device capable of utilizing charge sharing to reduce the power consumption in an LCD device.

2. Description of the Prior Art

Please refer to FIG. 1. FIG. 1 shows a simplified block diagram of a conventional gate driving device 100 utilized in an LCD device (not shown) according to prior art. As shown in FIG. 1, the gate driving device 100 comprises: a shift register 110, a logic circuit module 120, a level shifting module 130, and a plurality of output buffer units 140.

Please refer to FIG. 2. FIG. 2 shows a signal timing diagram of the gate signals CH1, CH2, CH3, CH4, . . . , CHn-1, CHn generated by the conventional gate driving device 100. As shown in FIG. 2, this kind of signal wave obviously requires the conventional gate driving device 100 to output greater current during charging/discharging process, and it results in a problem of higher power consumption.

### SUMMARY OF THE INVENTION

It is therefore one of the objectives of the present invention to provide a gate driving device utilized in an LCD device, and the gate driving device is capable of utilizing charge sharing to reduce the power consumption to solve the above problem.

According to an embodiment of the present invention, a gate driving device utilized in an LCD device is disclosed. The LCD device comprises a plurality of gate lines, and the gate driving device comprises: a plurality of output buffer units, at least a first switch unit, a plurality of second switch units, and a control module. The output buffer units are utilized for generating a plurality of gate signals and outputting the gate signals to the gate lines, respectively. The at least a first switch unit is coupled between two adjacent specific gate lines of the gate lines. The second switch units are respectively coupled to the gate lines, and each second switch unit is coupled between a specific gate line corresponding to the second switch unit of the gate lines and an output terminal of a specific output buffer unit corresponding to the specific gate line of the output buffer units. The control module is coupled to the first switch unit and the second switch units, and utilized for generating a first set of control signals according to a plurality of input signals of the LCD device to determine whether to conduct the first switch unit and whether to conduct the second switch units, wherein when the control module generates the first set of control signals to conduct the first switch unit and to un-conduct the second switch units corresponding to the two specific gate lines, the two specific gate lines perform charge sharing.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a simplified block diagram of a conventional gate driving device utilized in an LCD device according to prior art.

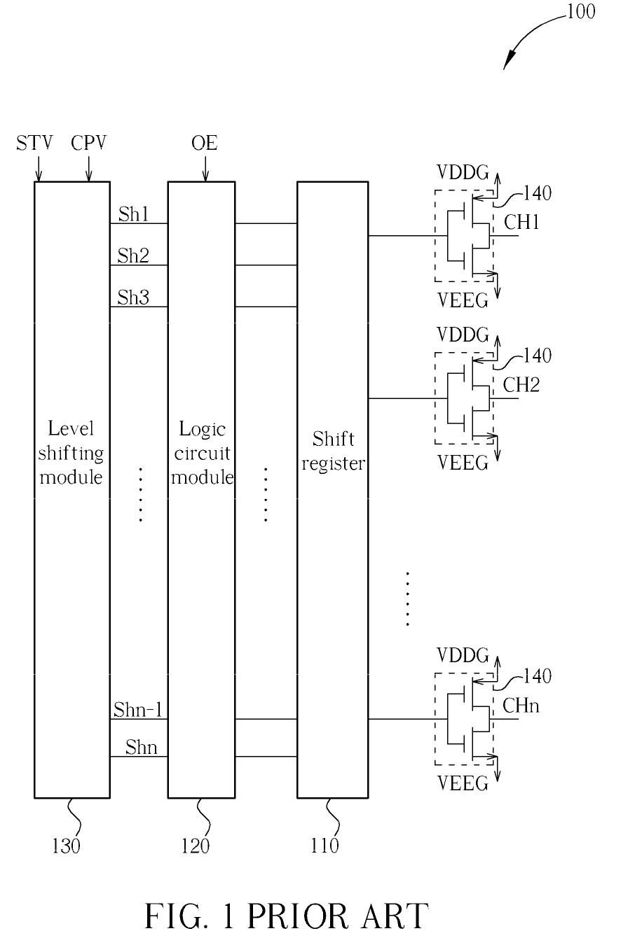

FIG. 2 shows a signal timing diagram of the gate signals CH1, CH2, CH3, CH4, . . . , CHn-1, CHn generated by the conventional gate driving device.

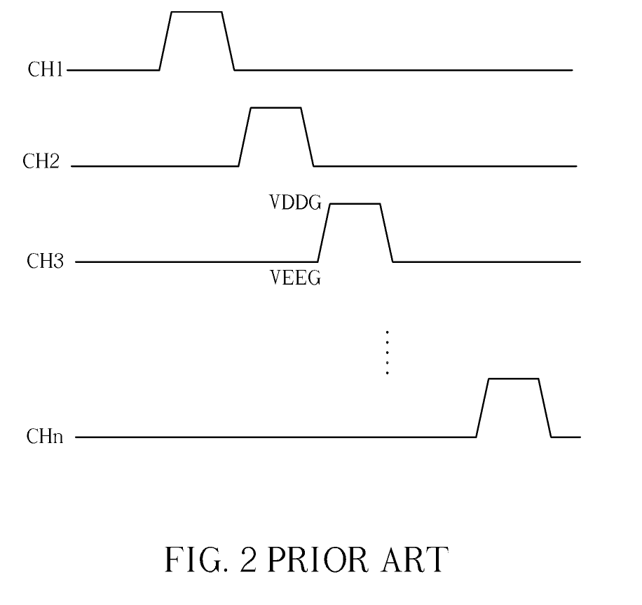

FIG. 3 shows a simplified block diagram of a gate driving device utilized in an LCD device according to an embodiment of the present invention.

FIG. 4 shows a signal timing diagram of the STV signal STV, the CPV signal CPV, the output enable signal OE, the shift signals Sh1, Sh2, Sh3, . . . , Shn-1, Shn, the control signals Ctrl1, Ctrl 2, Ctrl 3, . . . , Ctrl n-1, Ctrl n, the first set of control signals S1′, T2′, S2′, T3′, S3′, T4′, . . . , Sn-1′, Tn-1′, Tn′, and the gate signals CH1, CH2, CH3, CH4, . . . , CHn-1, CHn in the above embodiment of the present invention.

FIG. 5 shows a zoom-in wave diagram of the gate signals CH2, CH3 in FIG. 4.

FIG. 6 shows a simplified block diagram of the control module according to an embodiment of the present invention.

### DETAILED DESCRIPTION

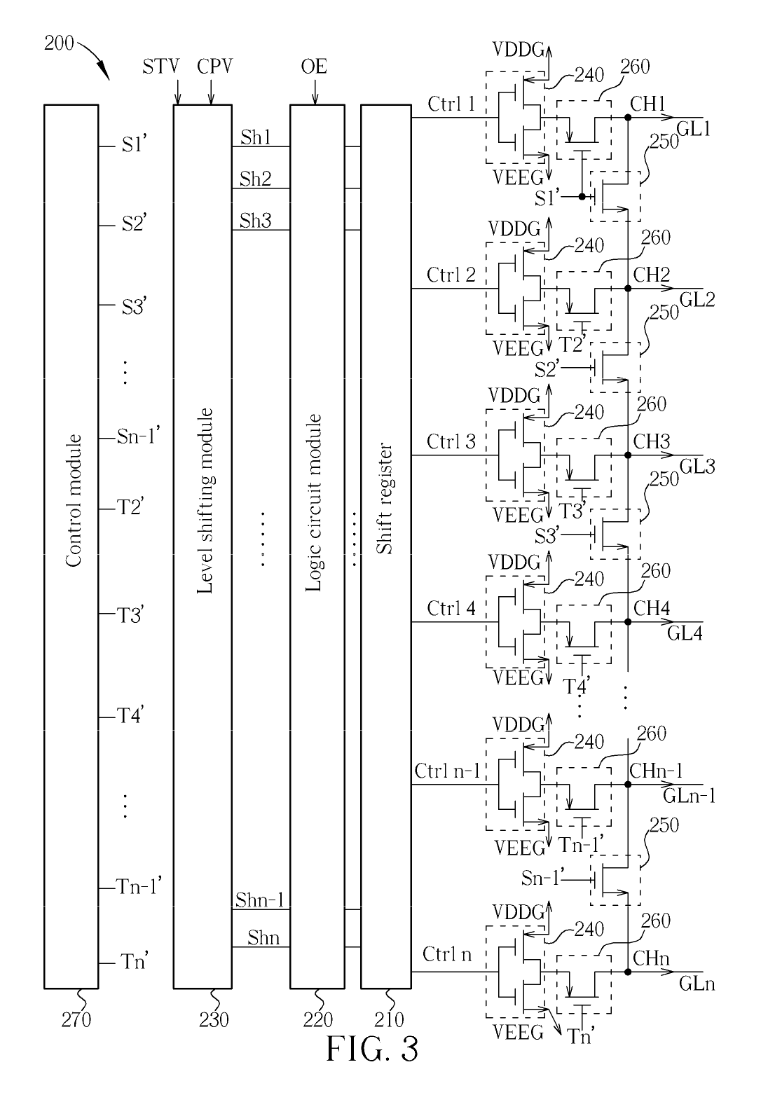

Please refer to FIG. 3. FIG. 3 shows a simplified block diagram of a gate driving device 200 utilized in an LCD device (not shown) according to an embodiment of the present invention. As shown in FIG. 3, the LCD device comprises a plurality of gate lines GL1, GL2, GL3, GL4, . . . , GLn-1, GLn, and the gate driving device 200 comprises: a shift register 210, a logic circuit module 220, a level shifting module 230, a plurality of output buffer units 240, a plurality of first switch unit 250, a plurality of second switch units 260, and a control module 270. The output buffer units 240 are utilized for generating a plurality of gate signals CH1, CH2, CH3, CH4, . . . , CHn-1, CHn and outputting the gate signals CH1, CH2, CH3, CH4, . . . , CHn-1, CHn to the gate lines GL1, GL2, GL3, GL4, . . . , GLn-1, GLn, respectively. Each of the first switch units 250 is coupled between two adjacent specific gate lines (e.g. between the gate lines GL1, GL2, between the gate lines GL2, GL3) of the gate lines GL1, GL2, GL3, GL4, . . . , GLn-1, GLn. The second switch units 260 are respectively coupled to the gate lines GL1, GL2, GL3, GL4, . . . , GLn-1, GLn, and each second switch unit 260 is coupled between a specific gate line (e.g. the gate line GL1) corresponding to the second switch unit 260 of the gate lines GL1, GL2, GL3, GL4, . . . , GLn-1, GLn and an output terminal of a specific output buffer unit 240 corresponding to the specific gate line of the output buffer units 240. The control module 270 is coupled to the first switch unit 250 and the second switch units 260, and utilized for generating a first set of control signals S1′, T2′, S2′, T3′, S3′, T4′, . . . , Sn-1′, Tn-1′, Tn′ according to a plurality of input signals of the LCD device to determine whether to conduct the first switch units 250 and whether to conduct the second switch units 260. In addition, the first switch units 250 all are N-type FETs (such as NMOSFETs) and the second switch units 260 all are P-type FETs (such as PMOSFETs) in the circuit configuration of this embodiment. Each of the first switch units 250 has a control terminal (i.e. a gate terminal) coupled to the control module 270, a first terminal (i.e. a source terminal) coupled to a gate line (e.g. the gate line GL1) of two adjacent specific gate lines (e.g. between the gate lines GL1, GL2) of the gate lines GL1, GL2, GL3, GL4, . . . , GLn-1, GLn, and a second terminal (i.e. a drain terminal) coupled to another gate line (e.g. the gate line GL2) of the two specific gate lines. Each of the second switch units 260 has a control terminal coupled to the control module 270, a first terminal (i.e. a source terminal) coupled to an output terminal (i.e. a gate terminal) of a specific output buffer unit 240 corresponding to the second switch unit 260 of the output buffer units 240, and a second terminal (i.e. a drain terminal) coupled to specific gate line (e.g. the gate line GL1) corresponding to the second switch unit 260 of the gate lines GL1, GL2, GL3, GL4, . . . , GLn-1, GLn.

In addition, please note that the input signals of the LCD device comprise an STV signal STV, a CPV signal CPV, an output enable (OE) signal OE, and a plurality of shift signals Sh1, Sh2, Sh3, . . . , Shn-1, Shn. The shift register 210, the logic circuit module 220, and the level shifting module 230 are utilized for generating a plurality of control signals Ctrl1, Ctrl 2, Ctrl 3, . . . , Ctrl n-1, Ctrl n to the output buffer units 240 according to the STV signal STV, the CPV signal CPV, the output enable signal OE, and the shift signals Sh1, Sh2, Sh3, . . . , Shn-1, Shn.

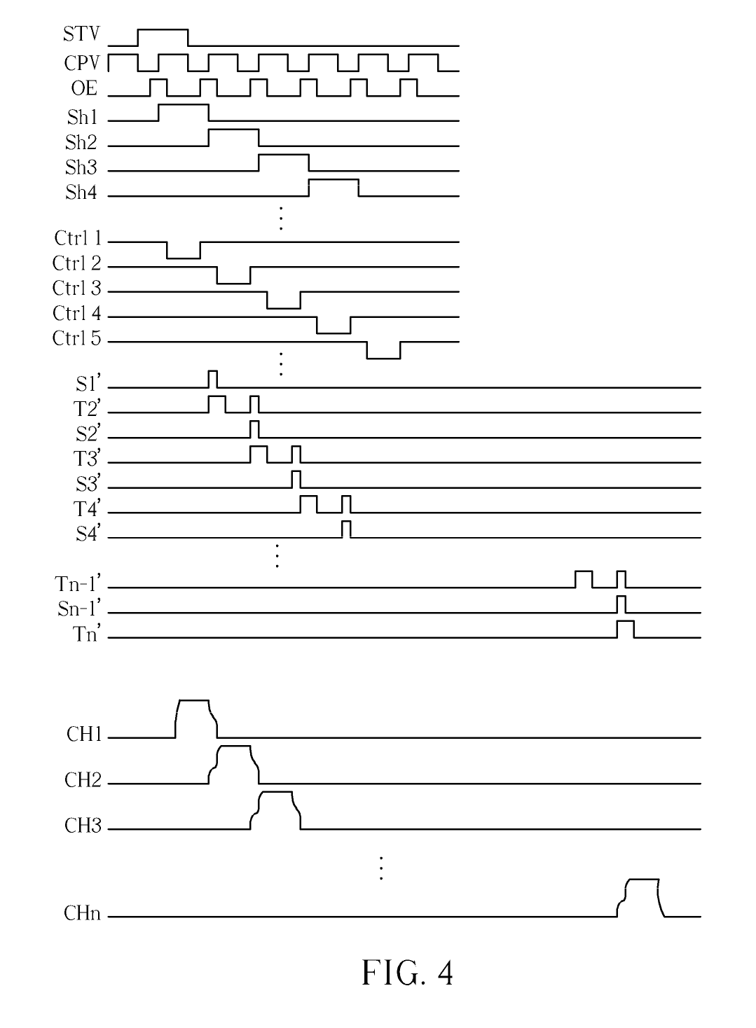

Please refer to FIG. 4. FIG. 4 shows a signal timing diagram of the STV signal STV, the CPV signal CPV, the output enable signal OE, the shift signals Sh1, Sh2, Sh3, . . . , Shn-1, Shn, the control signals Ctrl1, Ctrl 2, Ctrl 3, . . . , Ctrl n-1, Ctrl n, the first set of control signals S1′, T2′, S2′, T3′, S3′, T4′, . . . , Sn-1′, Tn-1′, Tn′, and the gate signals CH1, CH2, CH3, CH4, . . . , CHn-1, CHn in the above embodiment of the present invention. Next, this document will utilize a rising edge of the gate signal CH2 and a descending edge of the gate signal CH3 in FIG. 4 to illustrate the operation process of utilizing charge sharing to reduce the power consumption in detail.

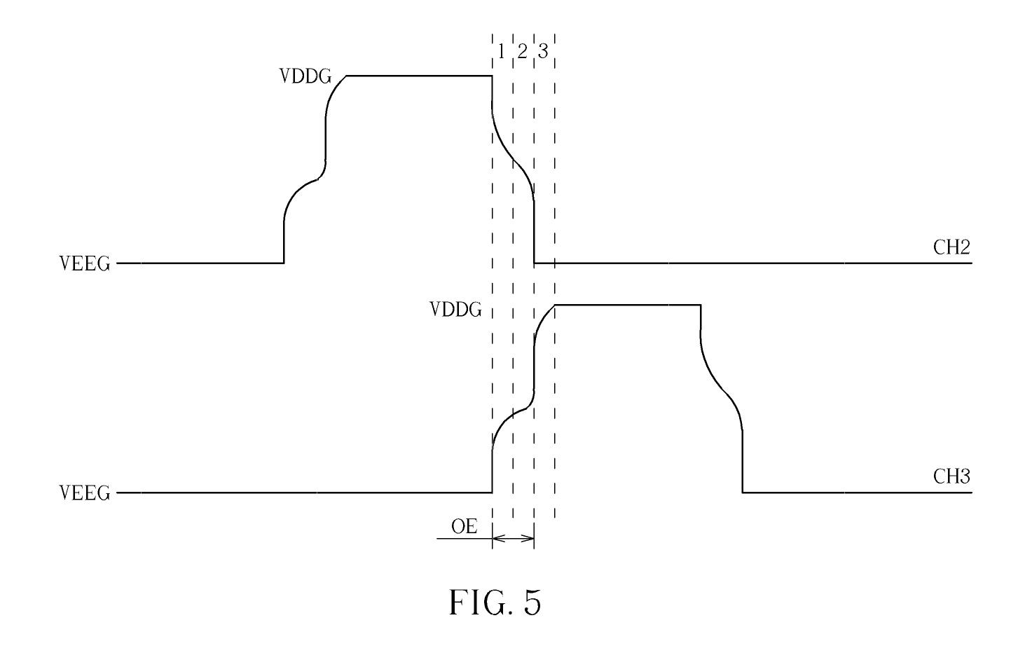

Please refer to FIG. 5. FIG. 5 shows a zoom-in wave diagram of the gate signals CH2, CH3 in FIG. 4. As shown in FIG. 5, during period 1, S2′ in the first set of control signals generated by the control module 270 conducts the first switch unit 250 coupled between the gate lines GL2, GL3, and T2′ in the first set of control signals un-conducts the second switch unit 260 coupled to the gate line GL2, and T3′ in the first set of control signals un-conducts the second switch unit 260 coupled to the gate line GL3, so as to let the gate lines GL2, GL3 perform charge sharing. Meanwhile, high level VDDG of the gate signal CH2 and low level VEEG of the gate signal CH3 are neutralized during the period 1.

Next, after the levels of the gate signals CH2, CH3 are neutralized, S2′ in the first set of control signals generated by the control module 270 will un-conduct the first switch unit 250 coupled between the gate lines GL2, GL3, and T2′ in the first set of control signals will conduct the second switch unit 260 coupled to the gate line GL2, to pull down the level of the gate signal CH2 to the low level VEEG from the neutralized level during period 2. T3′ in the first set of control signals still un-conducts the second switch unit 260 coupled to the gate line GL3, so as to form a floating status between the gate line GL3 and a corresponding output buffer unit 240. After output of the output buffer unit 240 corresponding to the gate line GL3 becomes the high level VDDG (i.e. during period 3), T3′ in the first set of control signals will conduct the second switch unit 260 coupled to the gate line GL3, so as to pull up the level of the gate signal CH3 to the high level VDDG.

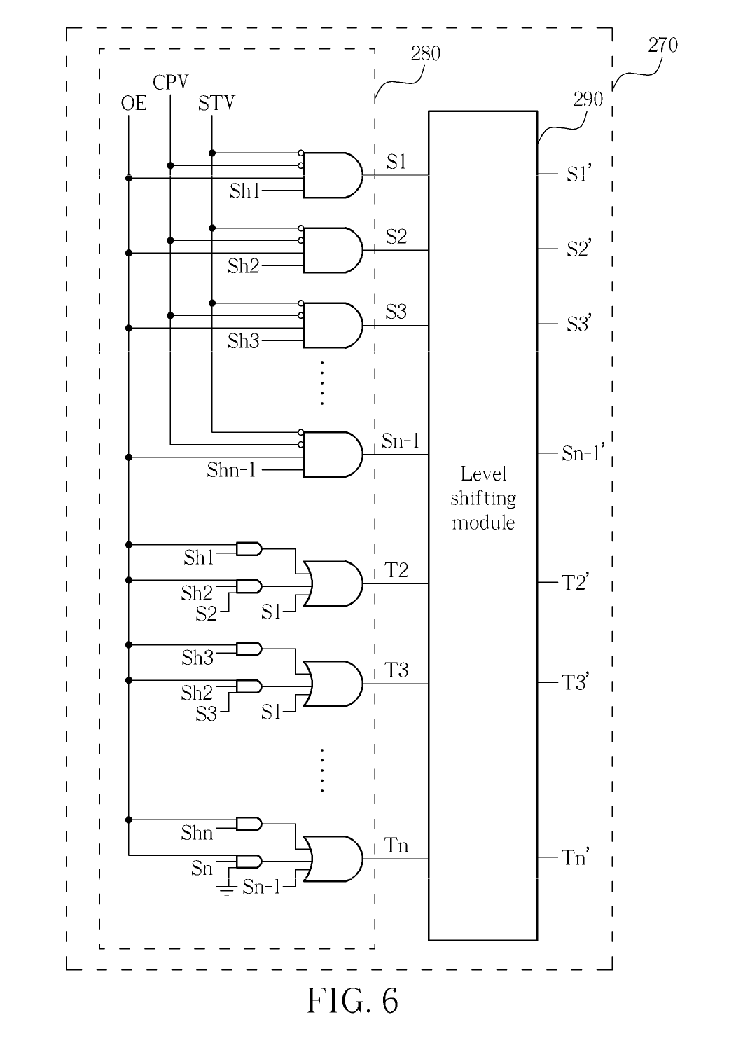

In addition, the control module 270 can further comprises a logic circuit module 280 and a level shifting module 290. Please refer to FIG. 6. FIG. 6 shows a simplified block diagram of the control module 270 according to an embodiment of the present invention. As shown in FIG. 6, the logic circuit module 280 is utilized for generating a second set of control signals S1, T2, S2, T3, S3, T4, . . . , Sn-1, Tn-1, Tn according to the STV signal STV, the CPV signal CPV, the output enable signal OE, and the input signals Sh1, Sh2, Sh3, . . . , Shn-1, Shn. The level shifting module 290 is utilized for level shifting the second set of control signals S1, T2, S2, T3, S3, T4, . . . , Sn-1, Tn-1, Tn to generate the first set of control signals S1′, T2′, S2′, T3′, S3′, T4′, . . . , Sn-1′, Tn-1′, Tn′. In addition, please note that the above embodiment is only for an illustrative purpose and is not meant to be a limitation of the present invention.

Briefly summarized, the gate driving device disclosed in the present invention can utilize charge sharing to reduce the power consumption, so as to attain the purpose of efficiently saving the power.

Those skilled in the art will readily observe that numerous modifications and alterations of the device and method may be made while retaining the teachings of the invention.

What is claimed is:

1. A gate driving device utilized in an LCD device comprising a plurality of gate lines, the gate driving device comprising:
a plurality of output buffer units, for generating a plurality of gate signals and outputting the gate signals to the gate lines, respectively;
at least a first switch unit, coupled between two adjacent specific gate lines of the gate lines;
a plurality of second switch units, respectively coupled to the gate lines, each second switch unit is coupled between a specific gate line corresponding to the second switch unit of the gate lines and an output terminal of a specific output buffer unit corresponding to the specific gate line of the output buffer units; and
a control module, coupled to the first switch unit and the second switch units, for generating a first set of control signals according to a plurality of input signals of the LCD device to determine whether to conduct the first switch unit and whether to conduct the second switch units, wherein when the control module generates the first set of control signals to conduct the first switch unit and to un-conduct the second switch units corresponding to the two specific gate lines, the two specific gate lines perform charge sharing.

2. The gate driving device of claim 1, wherein the control module further comprises:
a logic circuit module, for generating a second set of control signals according to the input signals, respectively; and
a level shifting module, for level shifting the second set of control signals to generate the first set of control signals.

3. The gate driving device of claim 2, wherein the input signals of the LCD device comprise an STV signal, a CPV signal, an output enable (OE) signal, and a plurality of shift signals.

4. The gate driving device of claim 1, wherein when two gate signals of the two specific gate lines respectively correspond to a rising edge transition and a descending edge transition, the control module generates the first set of control signals to conduct the first switch unit and to un-conduct the second switch units corresponding to the two specific gate lines to perform charge sharing for the two gate signals; when levels of the two gate signals are neutralized, the control module generates the first set of control signals to un-conduct the first switch unit and to conduct the second switch units corresponding to the two specific gate lines to stop charge sharing for the two gate signals.

5. The gate driving device of claim 1, wherein the first switch unit has a control terminal coupled to the control module, a first terminal coupled to a gate line of the two specific gate lines, and a second terminal coupled to another gate line of the two specific gate lines.

6. The gate driving device of claim 1, wherein each of the second switch units has a control terminal coupled to the control module, a first terminal coupled to the output terminal of the specific output buffer unit corresponding to the second switch unit of the output buffer units, and a second terminal coupled to specific gate line corresponding to the second switch unit of the gate lines.

7. The gate driving device of claim 1, wherein the first switch unit and the second switch units all are transistors.

8. The gate driving device of claim 7, wherein the first switch element is an N-type FET, and the second switch units all are P-type FETs.
